(19) United States
(12) Patent Application Publication
(10) Pub. No.: US 2014/0143032 A1
(43) Pub. Date: May 22, 2014

(54) SYSTEM AND METHOD FOR GENERATING 'RARE CROWD' INVENTORY FOR ADVERTISING

(71) Applicant: RARE CROWDS, INC., Bellevue, WA (US)

(72) Inventors: G. Scott Tomlin, Bellevue, WA (US); Eric Picard, Redmond, WA (US); Patrick Yannul, Seattle, WA (US); Richard Arneson, Brier, WA (US); Ratha Grimes, Seattle, WA (US); Benjamin Woodall, Seattle, WA (US); Thomas Sandholm, Pittsburgh, PA (US)

(73) Assignee: RARE CROWDS, INC., Bellevue, WA (US)

(21) Appl. No.: 14/066,471

(22) Filed: Oct. 29, 2013

Related U.S. Application Data
(60) Provisional application No. 61/719,733, filed on Oct. 29, 2012.

(51) Int. Cl. G06Q 30/02

(52) U.S. Cl. CPC G06Q 30/0241
USPC 705/14.4

(57) ABSTRACT

A system and method of procuring an advertising inventory over a communications network may include establishing a set of nodes defined by desired component attributes of inventory for an advertiser for an ad campaign. The established set of nodes may be stored. Valuation of nodes having unknown price and volume parameters may be estimated. The set of nodes may be explored to determine estimated price and volume parameters for the nodes. The set of nodes may be exploited for the ad campaign, where the exploitation may be inclusive of at least one extrapolated node having an estimated valuation. Results of the exploited set of nodes for the ad campaign may be generated.

### RELATED APPLICATIONS

This Application claims priority to co-pending U.S. Provisional Patent Application Ser. No. 61/719,733 filed on Oct. 29, 2012, the contents of which are hereby incorporated by reference in their entirety.

### BACKGROUND

### Advertising Ecosystem Landscape and Background

The typical process of an advertising sale begins with a media buyer who sends a Request for Proposal (RFP) document to numerous publishers. An RFP is typically written in prose, and defines (i) the overall goals of the advertiser in question, and (ii) the specific campaign being executed. A typical RFP has between 50 and 100 elements that are laid before the publisher as acceptable or desirable outcomes, where these elements (attributes or attributes of the buy) are generally descriptors (i) of the audience, (ii) of the media on which the advertiser is looking to run on, (iii) of the acceptable (and unacceptable) content or content category with which to be associated, (iv) of the publisher and publisher quality score, (v) of the creative dimensions and type, (vi) of other audience and non-audience attributes, etc.

Advertising inventory is the base unit sold by a publisher to an advertiser. It is measured in “impressions,” which are defined as an opportunity to show an advertisement to a person or viewer. Impressions at their most basic are blank vessels made up of opportunity. As understood in the art, inventory is generally defined in advance by the seller based on a variety of factors, and it is these predefined impressions that are contractually agreed up on between buyer and seller of ad space in digital media.

Nearly all impressions sold by a human sales force are made up initially of one or two media attributes based on content association. Examples of online content association may be provided as: MSN>Entertainment, MSN>Entertainment>Celebrities, Yahoo!>Autos, and Yahoo!>Autos>News. Further refinement of the inventory is based on other attributes, such as “Above the fold,” “Rich Media” units, or a variety of quality scores. Additional attributes included in the definition of a piece of sold inventory include various types of targeting and other types of intelligence and filtering, such as quality scores and contextual targeting, as well as numerous targeting attributes, such as geographic, demographic, psychographic, behavioral, etc.

It is the combination of these various attributes that define the inventory that is sold. Inventory is sold in a number of ways, including on a guaranteed basis (a buyer contracts with a seller for a fixed volume of inventory between specific dates) and on a non-guaranteed basis (if inventory is available that matches, it will be sold, but the seller does not make any guarantees on volume).

In order to predict how much inventory will be available, ad platforms look at historical data with seasonality and apply some very sophisticated algorithms to make a guess as to how much inventory will be available during specific date ranges. These “avails” as they are called become the basis for how all guaranteed ad sales are done. But this prediction is extremely technically challenging, and nobody has been able to accurately predict how much inventory will be available in advance for more than 3-4 targeting attributes. As a result, publishers rarely sell inventory that contains more than 3-4 attributes because this causes an immense amount of work to be done during a live ad campaign by the publisher's ad operations team, as to do so, a publisher would have to monitor ad delivery carefully, continuously, and timely adjust numerous settings in order to ensure delivery of the campaign.

Inventory is typically sold within a contract called an “insertion order” (I/O), and each sold element is typically called a “line item” on the I/O. Line items correspond to a variety of attributes within the publisher's inventory management systems. A simple example is: MSN>Entertainment. A more complex example is: MSN>Entertainment>Women>18-34.

Beyond a typical “guaranteed media buy,” there are several other mechanisms for selling ads. Some ads are ‘re-sold’ by a third party, such as an ad network. Examples of ad networks include Collective Media, Value Click, Advertising.com, etc. Some ads are sold through an automated channel, such as a Supply Side Platform (SSP). Examples of SSPs include The Rubicon Project, AdMeld, Pubmatic, etc. These SSPs then create a marketplace that allows ad networks to compete for the inventory in real-time, as well as exposing inventory in real-time to ad exchanges. These real-time sales are generally referred to as Real-Time Bidding (RTB), even though in some cases this term does not apply exactly.

The management systems for buying RTB inventory are generally called Demand Side Platforms (DSPs). In RTB media buys, it is extremely rare to have more than 3-4 targeting attributes (just as in guaranteed media buys), not because of prediction, but because inventory that exists for each campaign or line item that contains more than 3-4 attributes delivers with extremely low volume. In fact, the amount of inventory available on a per-impression basis generally drops significantly with each new attribute. This means that a typical line item for an RTB campaign would look very much like the one for a guaranteed buy: Entertainment>Women>18-34.

For a DSP to spend an entire media buy at more than 4 targeting attributes, the buyer would have to manually create hundreds or thousands of ad campaigns that each would then be manually optimized and managed. Such manual optimization and management is not commercially feasible.

In summary, in a perfect world, advertisers would be able to find all available ad inventory that matches their goals with as many attributes that exist on all impressions. The problem is that existing inventory management and ad serving systems are not designed or capable of handling more than 2-3 targeting attributes, whether for guaranteed media buys or RTB.

Why do advertisers and publishers prefer to sell ads on a guaranteed basis?

Inventory guarantees serve several purposes. One reason for inventory guarantees is predictability—media buyers have agreed with the advertiser on a set advertising budget to be spent on a monthly or other timeframe basis throughout the year. The media buyers are contractually obligated to spend that budget and it is one of an advertiser's primary key performance indicators (KPIs). Publishers like to have revenue predictability as well, which is solved by selling a guarantee on volumes for a fixed budget.

However, inventory guarantees are extremely limiting—they create a huge amount of work on both the buy and sell side of the ecosystem, and ultimately the product being sold is quite limited (literally in the case of the number of attributes that can be sold on a guaranteed basis).

How Publishers View Inventory

Ad placement inventory is typically broken down into four buckets—Sponsorships, Premium Guaranteed, Audience Targeted, and Remnant. Each of these buckets can be sold through a variety of sales channels. With regard to FIG. 1, an illustration of an illustrative stack of ad placement inventories 100 categorized based on type of inventory is shown. In this case, the highest value inventory is at the top of the stack of ad placement inventories 100 and the lowest value inventory is at the bottom of the stack. In particular, hand-sold sponsorships inventory 102a, hand-sold premium inventory 102b, hand sold audience targeted inventory 102c, targeted inventory sold via ad exchanges 102d, and remnant “wholesale” inventory sold to ad networks 102e range from highest value to lowest value. Of course, any of the hand-sold inventory is the most expensive because the inventory is custom selected for an ad campaign.

With regard to FIG. 2, an illustration of an illustrative revenue distribution 200 over the stack of ad placement inventories 100 of FIG. 1 is shown. The revenue distribution is configured as an inverted pyramid across the ‘layer-cake’ or stack of ad placement inventories, and flows downward with the vast majority of revenue 202a coming from the premium ad placement inventories and a significantly lower amount of revenue 202b, 202c, and 202d coming from the remainder of the ad placement inventories. As understood in the art, the stack of ad placement inventories 100 have a limited number of attributes, generally two or three, that are used by the industry as higher numbers of attributes are too difficult due to processing and other reasons.

### SUMMARY

To overcome the shortcomings of limited capabilities of attribute prediction and, hence, attributes within ad placement inventory models or advertising audiences, the principles of the present invention provide for using combinational mathematics of audience attributes integrated with a process for estimating and generating actual price and volume metrics for each combination of attributes. As a result of using the principles of the present invention, higher order attribute predictions and combination, and, hence, higher quality and rarer audiences may be produced so that advertisers may more efficiently target audiences or attributes that have heretofore been unavailable to advertisers.

One embodiment of a method of procuring an advertising audience over a communications network may include establishing a set of nodes defined by desired component attributes of inventory for an advertiser for an ad campaign. The established set of nodes may be stored. Valuation of nodes having unknown price and volume parameters may be estimated. The set of nodes may be explored to determine estimated price and volume parameters for the nodes. The set of nodes may be exploited for the ad campaign, where the exploitation may be inclusive of at least one extrapolated node having an estimated valuation. Results of the exploited set of nodes for the ad campaign may be generated.

One embodiment of a system for procuring an advertising audience over a communications network may include a storage unit configured to store at least one data repository and a processing unit in communication with the storage unit. The processing unit may be configured to establish a set of nodes defined by desired component attributes of inventory for an advertiser for an ad campaign, store the established set of nodes in the at least one data repository, and estimate valuation of nodes having unknown price and volume parameters. The processing unit may further be configured to explore the set of nodes to determine estimated price and volume parameters for the nodes, exploit the set of nodes for the ad campaign, where the exploitation inclusive of at least one extrapolated node having an estimated valuation, and generate results of the exploited set of nodes for the ad campaign.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an illustrative stack of ad placement inventories categorized based on type of inventory;

FIG. 2 is an illustration of an illustrative revenue distribution over the stack of ad placement inventories of FIG. 1;

FIG. 3 is an illustration of an illustrative alternative ad placement inventories stack or layer-cake model;

FIG. 4 is an illustration of an illustrative ‘rare crowd’ revenue model that overlays the ad placement inventories stack of FIG. 3;

FIG. 5 is an illustration of the hand sold sponsorships of FIG. 1 mapped onto the broad reach (sponsorships) parameter of FIG. 3 and the hand sold premium inventory of FIG. 1 is mapped onto the two to three parameter media buys of FIG. 3, while the remaining parameters are meant to replace the lower value inventory;

FIGS. 6A and 6B are illustrative pie charts showing different audience segmentations that show the impact of the ‘rare crowd’ (FIG. 6B) verses a traditional audience package (FIG. 6A) inclusive of both volume and CPM with very conservative considerations;

FIG. 7 is a power set graph showing an illustrative ad inventory defined in a way that can be visualized;

FIG. 8 is a power set graph showing an illustrative set of nodes having three tiers, Tiers 1, 2, and 3;

FIG. 9 is an illustration of another power set graph showing an illustrative ad inventory;

FIG. 10 is an illustration of an illustrative network environment in which a computing system, such as a computer server operating on a communications network, that provides communicative access to publisher server(s) and exchange servers;

FIG. 11 is a flow diagram of an illustrative inventory procurement process that may be executed by a computing system, such as computing system, in accordance with the principles of the present invention;

FIG. 12 is a sequence diagram of a process for performing an advertising campaign that includes a ‘rare crowd’ inventory;

FIG. 13 is a screen shot of an illustrative user interface that enables an advertiser or its agency to create an ad campaign inclusive of ‘rare crowd’ inventory;

FIG. 14 is a stack of illustrative inventory definitions;

FIG. 15 is a stack of illustrative ‘rare crowd’ inventory with ad campaigns examples; and

FIG. 16 is a screen shot of an illustrative map or graph showing allocations of different levels of ‘rare crowd’ inventory.

### DETAILED DESCRIPTION OF THE DRAWINGS

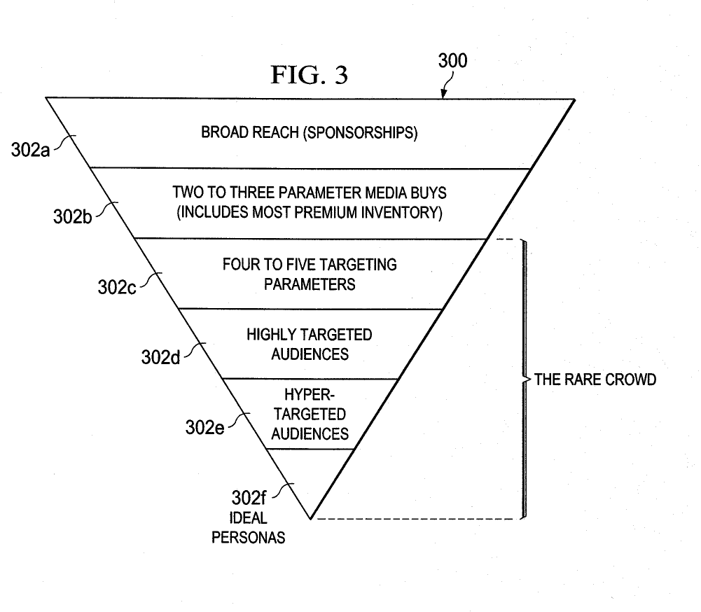

With regard to FIG. 3, an illustration of an illustrative alternative ad placement inventories stack or layer-cake model 300 is shown. As shown, this narrowly defined model 300 segments the less valuable inventory, such as the remnant “wholesale” inventory that was previously low value inventory, into higher value inventory as a result of being able to define and identify a number of targeting inventory parameters, including broad reach (sponsorships) 302a, two to three parameter media buys that includes most premium inventory 302b, four to five targeting inventory parameters or attributes 302c (‘rare’ inventory, which is not the same as a ‘rare crowd’ inventory that covers inventory with four and higher number of attributes), highly targeted audiences 302d, hyper-targeted audiences 302e, and ideal personas 302f, where parameters 302c-302f are considered to be a “rare crowd” inventory. It should be understood that a “rare crowd” inventory may have additional and/or alternative targeted audiences as defined by attributes or parameters as those in parameters 302c-302f.

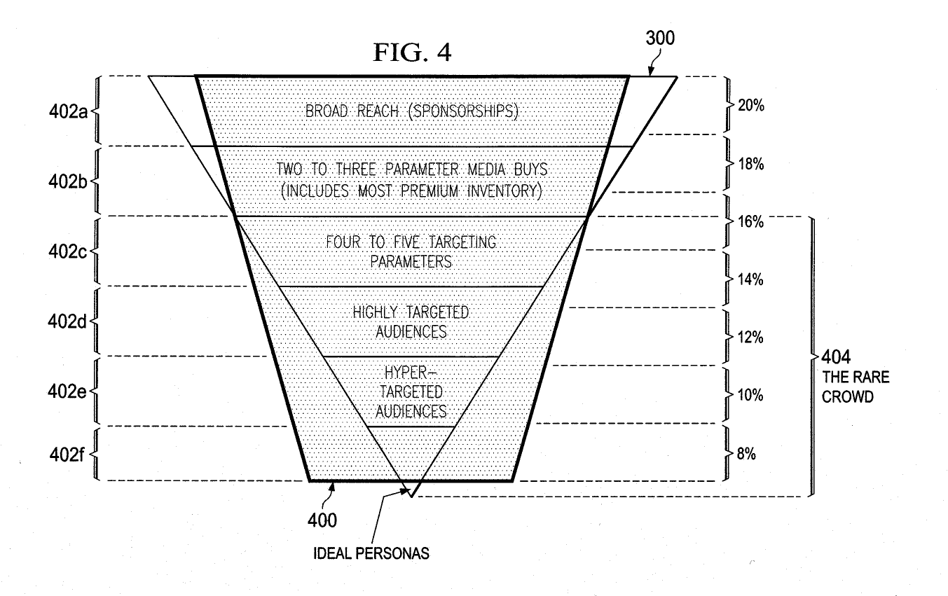

With regard to FIG. 4, an illustration of an illustrative ‘rare crowd’ revenue model 400 is shown to overlay the ad placement inventories stack 300 of FIG. 3. Because the inventory is being sliced into fine-grained definitions or parameters, and a great deal of ad spend budget is desired to be spent on the ‘rare crowd’ by an advertiser, the revenue model flows differently across the ‘rare crowd,’ as depicted by the ad placement inventories stack 300 of FIG. 3. As shown, one embodiment of the ‘rare crowd’ revenue model 400 provides for an ad spend that was previously flat for a low value inventory into a higher value inventory, and apportioned across the different inventory parameters of the ad placement inventories stack 300. In this model, the ‘rare crowd’ revenue model 400 may be set such that 20% of ad spend may be applied to inventory parameter 302a, 18% of ad spend may be applied to inventory parameter 302b, 16% of ad spend may be applied to inventory parameter 302c, 14% of ad spend may be applied to parameter 302d, 12% of ad spend may be applied to inventory parameter 302e, 10% of ad spend may be applied to inventory parameter 302f, and 8% of ad spend may be applied to inventory parameter 302g. That is, as a result of being able to target a ‘rare crowd’ inventory inclusive of inventory parameters 302c-302f that was previously unattainable, an ad campaign may be able to increase the ad spend for the previously low value audience as a result of being able to define and create inventory attributes that are more desirable for an advertiser, which allows for a higher and more evenly balanced ad spend across the ‘rare crowd’ audience 404.

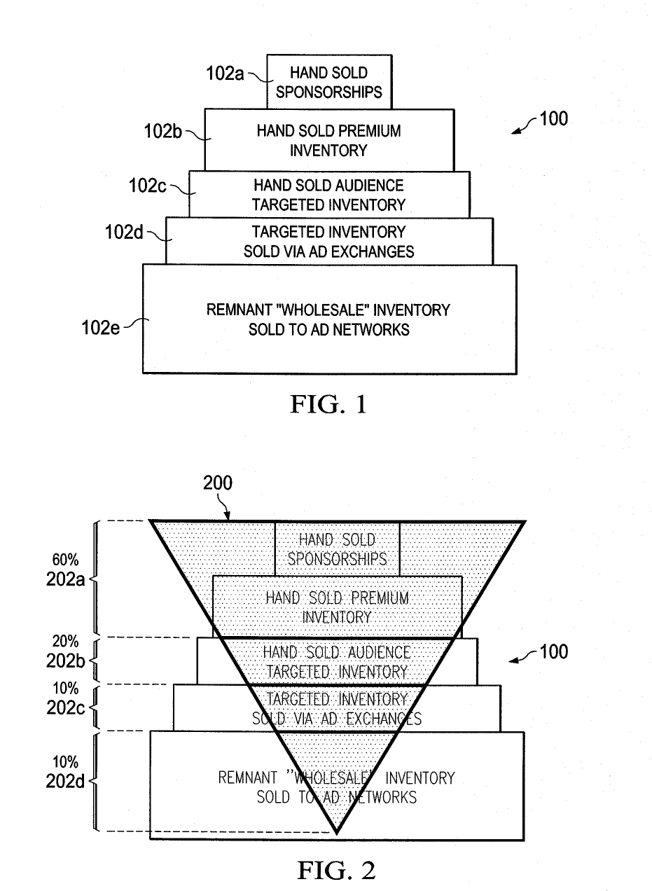

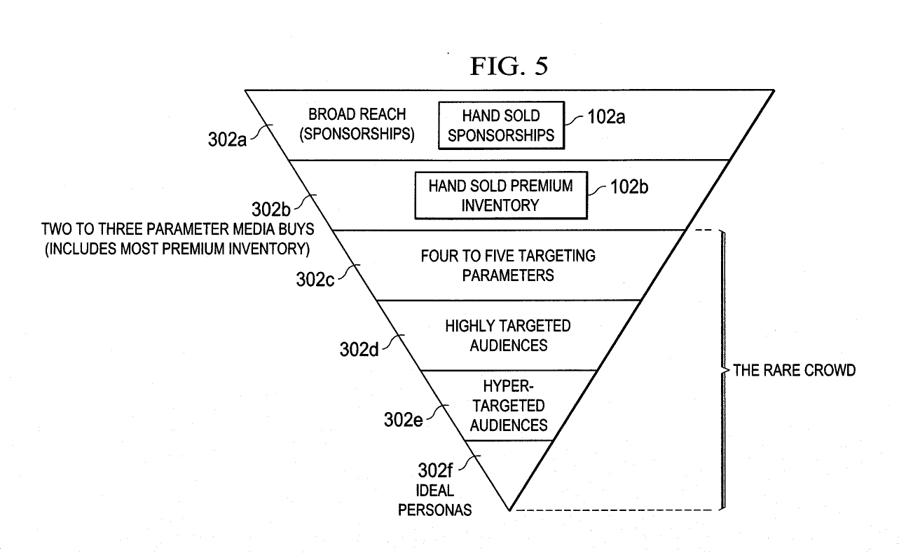

More particularly, this more refined view of inventory leads to significant gains in overall yield while not impacting or having minimal impact on key premium packages that sales forces desire to sell themselves. In fact, the premium sponsorships and premium inventory that drive most revenue for publishers will unlikely be impacted by the ‘rare crowds’ inventory model. To show the minimal impact, and with regard to FIG. 5, the hand sold sponsorships 102a of FIG. 1 are mapped onto the broad reach (sponsorships) parameter 302a of FIG. 3 and the hand sold premium inventory 102b of FIG. 1 is mapped onto the two to three parameter media buys 302b of FIG. 3, while the remaining parameters 302c-302f are meant to replace the lower value inventory, as further provided hereinbelow.

Packaging Inventory for Guaranteed Media Buys

Today, publishers sell two types of premium ad inventory: sponsorships and premium inventory, both of which are in short supply. To accommodate this shortfall, publishers create packages that add in audience targeted inventory and remnant inventory. This ‘dilutive’ approach causes problems since the buyer does not want the non-premium inventory as part of their package, and, thus, the advertiser pays less for the non-premium inventory. Bundling undesirable inventory with desirable inventory causes significant problems with media buyers.

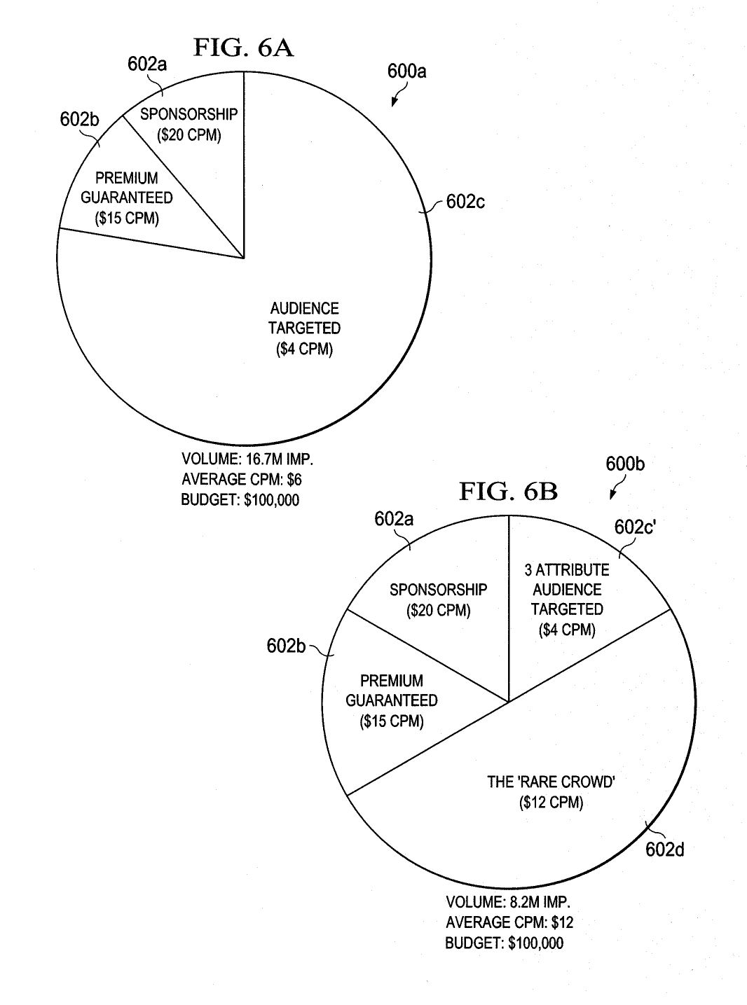

With regard to FIGS. 6A and 6B, illustrative pie charts 600a and 600b, respectively, showing different inventory segmentations show the impact of the ‘rare crowd’ (FIG. 6B) verses a traditional inventory package (FIG. 6A) inclusive of both volume and CPM with very conservative considerations are shown. As understood in the art, CPM varies based on many factors, including the publisher and advertiser. It should be understood that the volume of inventory and the exact breakdown of inventory that will be delivered is difficult to predict in a ‘rare crowd’ inventory, but the overall value proposition of the guaranteed media buy is the same. Effectively, an exchange rate between different components of a ‘rare crowd’ inventory, including price and volume, may be defined and/or estimated via mathematical calculations and ultimately measured by the principles of the present invention.

As shown, the sponsorship audience 602a and premium guaranteed audience 602b are valued at high CPMs at respective $20 CPM and $15 CPM rates relative to the remaining audience targeted 602c at $4 CPM. As provided in FIG. 6B, as a result of generating a ‘rare crowd’ audience 602d, a significant portion of the audience targeted 602c can be converted to a higher value audience, which also causes the lower value audience 602c to shrink to a smaller 3 attribute audience targeted 602c′. By the CPM of the ‘rare crowd’ audience 602d being higher than what is paid currently for targeted inventory (which only exists at tiers 1-3 today), overall yield may be increased as a result of increasing average CPM while reducing the amount of inventory needed to spend an budget—all while lowering cost of sales, which makes generating the ‘rare crowd’ audience a win-win for both the advertiser and publisher.

Finding the ‘Rare Crowd’ Inventory

The principles of the present invention provide for a new type of advertising system that was created from ground-up to define, price, and discover more highly targeted inventory than 1-3 attributes of an inventory. The system and method provide for pockets of audience that exist with 4+attributes that are small, but with many different pockets from which to choose. These small pockets of inventory (rare) may be aggregated together to form large pools of inventory and audience (crowds)—or the “rare crowd” inventory.

One of the valuable ‘side effects’ of selling the ‘rare crowd’ is that inventory volume guarantees are not required, but the buyer and seller still get the same desired predictability on budget being spent. And, since a ‘rare crowd’ package is always going,to be delivered according to the desire of the buyer, and at a higher quality bar than a guaranteed buy could deliver—the product is in many ways superior to existing premium ad packages.

A typical ‘rare crowd’ has between 10 and 20 base targeting elements, but higher numbers are certainly acceptable. In one embodiment, every possible combination of base attributes may be utilized, and a very large graph, such as a power set graph, as understood in the art, in which each node represents a combination of attributes may be created. To illustrate how large these graphs can get, here are some examples:

A 10 attribute graph totals 1,024 nodes.

A 15 attribute graph totals 32,768 nodes.

A 20 attribute graph totals 1,048,576 nodes.

In one embodiment, the graphs are not pure power set graphs, as some required mechanisms, such as “OR groups,” where a list of many different elements that can exist as “this” OR “that” attributes are included, can cause significant size increases in the graph beyond a simple power set. And, there are some techniques that can be used to shrink the size of the graph, such as ‘pinning’ of attributes. However, inventory definition graphs, which may be modified power set graphs as described above, are always larger than a human can comfortably comprehend.

By creating a large graph with many potential inventory definitions, experiments or simulations in the graph may be run to determine where pockets of inventory exist. By automating this experimentation, there are no lower limits of combinations of attributes (i.e., for each campaign, hundreds or thousands of nodes that have enough inventory to be combined together and spend the whole budget can be found).

The ‘rare crowd’ may be found by using the graph definitions, cost of inventory from a publisher plus a few inputs from the buyer. To start looking for ‘rare crowd’ inventory, experiments against a publisher's ad inventory (or across ad exchanges), which take the form of “line items,” where each line item represents a node in a graph, may be set up. A test budget may be allocated against each node being tested, and an experiment may be run for a fixed period of time. The experiments return what inventory is actually available at the pre-calculated price. If the budget was spent, the budget may be increased and another test may be run. If the budget was not spent, the node may be shut off and a new experiment may be create. This experiment process may be repeatedly run until the budget is spent, prioritizing higher value nodes in the graph.

As a result of utilizing the principles of the present invention, for the first time, advertisers can buy much more targeted inventory than ever before—at scale, meaning advertisers can spend a significant budget on the “rare crowd” inventory and get more of the audience or inventory that they want. But the “rare crowd” inventory is at least as helpful, if not more helpful, to the publisher as it is to the advertiser.

The “Rare Crowd” Maximizes Bid Density (Competition) for Inventory

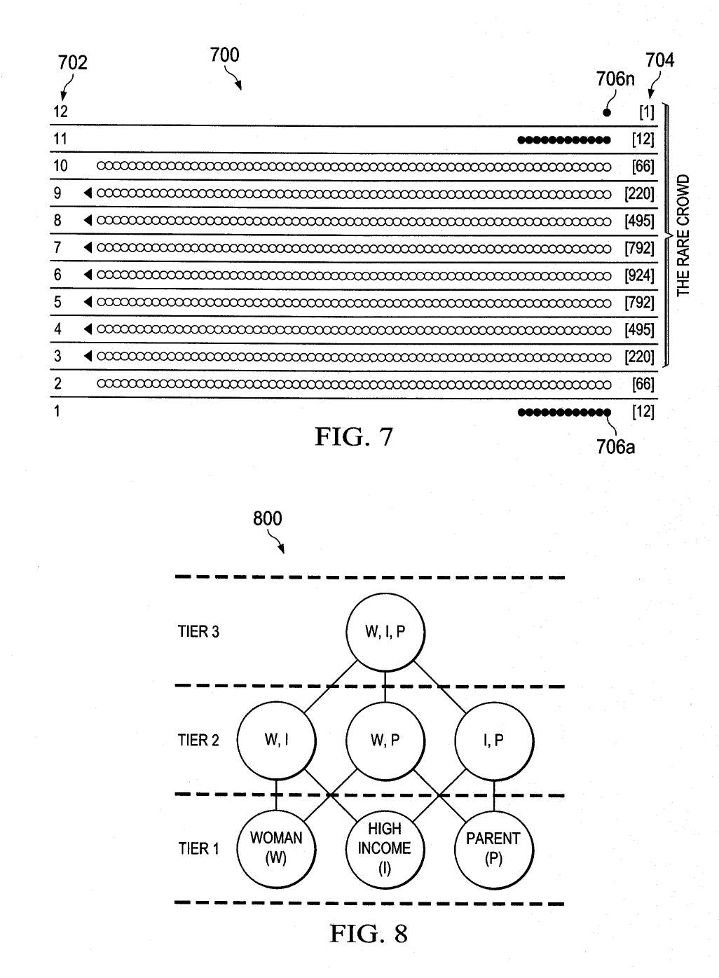

With regard to FIG. 7, a power set graph showing an illustrative ad inventory 700 defined in a way that can be visualized is shown. The power set graph shows each tier 702 and a number of nodes in each tier 704. Each node 706a-706n (collectively 706) in the graph represents some combination of inventory attributes (e.g., male, age range, city, etc.). The “rare crowd” inventory 708 in this graph exists from tier 4 through tier 12.

With regard to FIG. 8, power set graph showing an illustrative set of nodes 800 having three tiers, Tiers 1, 2, and 3, is shown. In one embodiment, each “parent” node in the set of nodes 800 in each of the three tiers is made up of the attributes of its “children” nodes below a “parent” node. As an example, consider a Tier 3 node made up of women (w) with a high income (i) who are parents (p). As shown, each tier of the power set graph contains nodes made p of that tier's number of attributes (e.g., Tier 3 nodes contain three audience attributes). This power set graph only has seven nodes. A bid on the W,I,P node causes competition with all of its children simultaneously—so one bid creates direct competition with seven potential other bids in an auction.

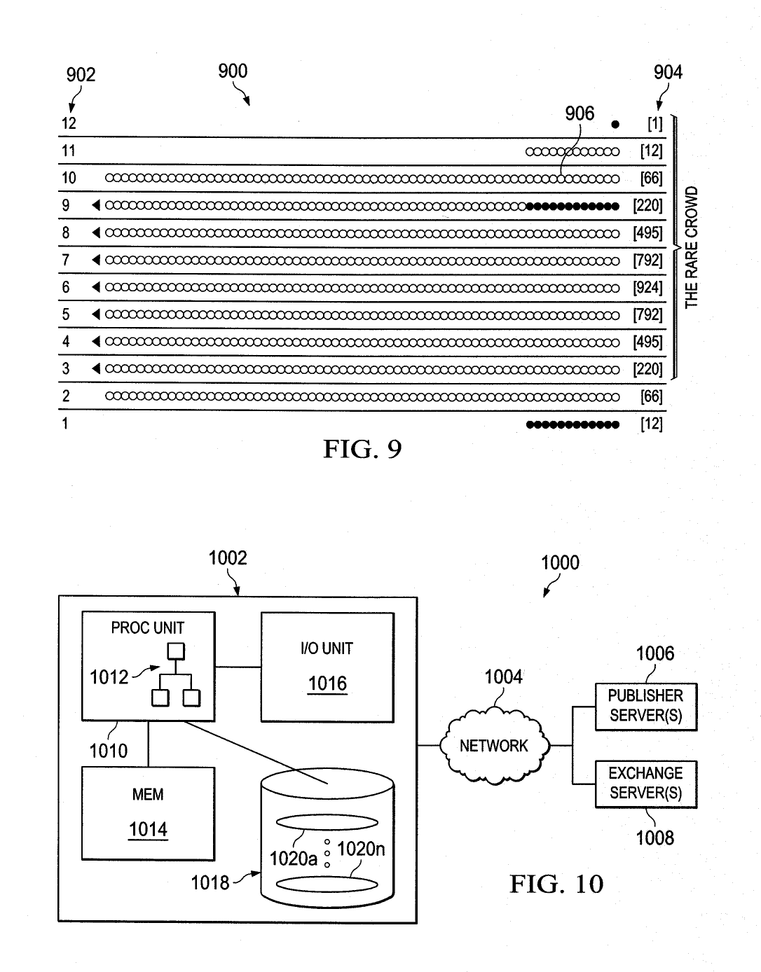

With regard to FIG. 9, an illustration of another power set graph showing an illustrative ad inventory 900 is shown. This power set graph shows 12 total tiers 902 and a number of nodes 904 in each tier. In one embodiment, a bid on a Tier 10 node 906 causes competition with 1,024 other potential bids in an auction simultaneously. Given that there is really no competition in advertising auctions above tier 4 today, for the purposes of illustration, only nodes that exist at tier 3 and below will be counted, which is 175 nodes at Tier 3 or lower (i.e., where existing competition currently exists.) It is likely that all 175 of those nodes would have existing bids in the auction, meaning that one bid caused 175 bids-worth of competition. As more simultaneous campaigns are run on any publisher's inventory—and as more publishers adopt this methodology in the exchange, competition will move higher and higher into the graph, thereby causing significant increases in bid density.

The concept of bid-density drives maximization of yield (extracting maximum revenue) for a publisher's inventory. The more bidders participating in the auction on any one piece of inventory, the faster that the ‘true price’ of that inventory is found, which allows the publisher to extract maximum yield. As a result of creating the ‘rare crowd’ audience inventory, advertisers are provided with more ideal inventory, which helps publishers increase yield to audiences that heretofore were unavailable. Ultimately this ‘rare crowd’ audience generation methodology may be the “Holy Grail” of advertising as it solves some of the most significant problems in the online advertising industry, and does so in a way that does not disintermediate any existing market participants in the industry. That is, each market participant in the existing advertising ecosystem can utilize the principles of the present invention in a complementary way to their existing business and services.

Managing the Concentration of Competition

The principles of the present invention may be utilized to find or identify ad impressions where potential massive competition, could exist, and can be used to concentrate that competition on specific pieces of inventory. A portion of the inventory may be carved out and represented in a dedicated marketplace. In one embodiment, the inventory that may be segregated is the highest value inventory that exists within any publisher's inventory. Alternative segregation of inventory may additionally or alternatively be segmented.

The idea of a ‘rare crowd’ inventory is that a small percentage of any publisher's inventory is generally high value to many advertisers—think of these as those with high income or who are in specific categories that match significant advertisers who are willing to pay a premium to reach a specific inventory. As an example of a theoretical ‘rare crowd’ person, (1) a 36 year old male, (2) who is a new parent, (3) who drives a 2009 Porsche 911, (4) who makes >$200 k annually, (5) who has investments in their portfolio over $2M, (6) who owns a home in Westchester, N.Y., (7) who bought his engagement ring and wedding ring at Zales, (8) who is an avid golfer, (9) who is a frequent flyer for business and vacations, (10) who has a large extended family, (11) who has season tickets at the Nicks and the Rangers, and (12) who plays ice hockey recreationally. Such a ‘rare crowd’ person (tier 12) is quite a valuable audience member to advertisers who desire to target any of those attributes at a level higher than tier 3 (e.g., (1) 36 year old male, (2) new parent, (3) Porsche 911, (4) Westchester, N.Y., and (5) avid golfer.

By way of contrast, in the current market, when an impression is captured for this person, he is relatively randomly assigned to an ad campaign that is for (hopefully) the highest yielding campaign among those that are active on that publisher's site at the moment the impression is generated. As an example, if active advertisers at the moment are Porsche, Ford, BMW, Zales, other jewelers, Callaway Golf, Sports Authority, Ebay, Virgin America, United Airlines, Pampers, Madison Square Garden, and any number of others interested in individual or groups of traits he's been assigned in targeting. While there's some macro-level competition over him today (prior to being able to generate a ‘rare crowd’ inventory), there is currently no direct micro-level competition for many reasons, including that each of those campaigns were bought from channel sales people at the publisher. Or perhaps that person was sold as remnant inventory, which is a shame since higher revenue could have been realized, and a few of those advertisers competed on single attributes for that person (i.e., advertising dollars were “left on the table” as a result of not being able to present that ‘rare crowd’ person to specialty advertisers to compete for delivering a targeted advertisement to that person.

Using the principles of the present invention, competition across large numbers of attributes on individual impressions may be maximized and significant competition may be built in real-time. A “high value inventory” marketplace that works with publishers to consolidate their highest value inventory into a dedicated marketplace to maximize competition may be created utilizing the principles of the present invention. A proof point in the market today is a particular media agency that is a very successful ad network focused on the high value inventory crowd. However, the media agency sells ad space using current techniques on small numbers of attributes and content associations, not technical approaches to increase competition.

In one embodiment, the system may be automated so as to maximize competition immediately, and can solve this problem for any publisher making use of existing infrastructure plus the processes described herein.

But are Advertisers Willing to Pay High CPMs for Ad Inventory?

As well understood in the art, both marketers and their media agencies very much want a high CPM super-premium form of inventory. As also understood in the art, the higher the number of matching attributes of an audience member, the more likely that audience member is willing to consider acting on an advertisement at that time or in the future. As a result of the increased value of a ‘rare crowd’ inventory, advertisers are more willing to pay a higher CPM for such an inventory even if it means advertising to a smaller number of people due to the advertisement being more efficient (i.e., more targeted to a specific inventory with more matching attributes of which the advertiser is seeking).

Why do Marketers Desire Super Premium Inventory, Such as HVA or Premium Inventory Such as the ‘Rare Crowd’ Inventory?

Digital media has historically been still considered ‘low end’ because of the massive amount of remnant inventory that exists online. TV and other media artificially limit the amount of remnant available for direct response (DR) buys—specifically television locks DR inventory on broadcast TV and cable to less than 10%. Magazines keep their non-premium inventory in the back of the magazine and make the ad units smaller.

Digital suffers from bad creative formats, inefficient buying (10-15× less efficient to buy online display than traditional media), and very low amounts of premium inventory. The most premium inventory today is a combination of custom formats, such as “home page takeovers” and “branded entertainment” ads, that are actually usually given away by the publisher as part of a bigger package that they require the buyer to pick up (i.e., publishers often use homepage takeovers as a loss leader). Thereafter, publishers give an advertiser a chunk of premium inventory, and then tonnage of remnant inventory with one targeting attribute applied at best.

Overall, this premium ad space giveaway diminishes the ‘stature’ of online media for both media buyers and marketers. Something that increases the stature of online media by providing something of high value to advertisers (other than extremely low cost with the downside of inefficient media management) is very desirable to the ecosystem. In other words, the television media buyer still owns the most prestigious spot in a media agency, and with a super-premium inventory type, online media buyers get some prestige of their own. This is not an economic or scientific issue—it is sociological and psychological.

Both the ‘rare crowd’ inventory and high value audience (HVA) create a more desirable form of inventory that is better than what exists today, and creates a new premium and super-premium type of brand-friendly ad inventory in a scalable way for advertiser and publisher.

The Rare Crowd Package Tools

The principles of the present invention may include an inventory packaging tool for publishers and other inventory owners. The tool may plug into a variety of inventory sources, including Doubleclick for Publishers, Various SSPs, Ad Exchanges, and proprietary inventory management systems (such as Microsoft's DAP and Yahoo's internal ad server), using plug-in techniques, as understood in the art.

This packaging system enables the account manager at a publisher to reply to an RFP with a new component, the ‘rare crowd’ inventory generator, which adds to the existing components of sponsorship, premium inventory, and targeted inventory. In other words, the ‘rare crowd’ inventory generator is a new premium inventory component configured to be added to advertising packages.

Inventory Procurement Module

Secondary features of this product may include inventory procurement functionality that allows a media buyer at a media agency, the publisher or ad network go out onto an advertising exchange and find additional matching inventory. Features within this set of functionality allow the media buyer, publisher or ad network to set margin on externally collected inventory so that overall margins may be controlled.

With regard to FIG. 10, an illustration of an illustrative network environment 1000 in which a computing system 1002, such as a computer server operating on a communications network 1004, that provides communicative access to publisher server(s) 1006 and exchange servers 1008. The computing system 1002 may include a processing unit 1010 configured to execute software 1012 that performs functionality for identifying and/or generating ‘rare crowd’ inventory of publishers, as described herein, and for enabling the exchange server(s) 1008 or other ad placement operators to view and schedule ad campaigns inclusive of the ‘rare crowd’ inventory (e.g., four or more attributes of inventory). The processing unit 1010 may be in communication with a memory 1014 configured to store data, such as attributes of inventory, and software, input/output (I/O) unit 1016 configured to communicate data over the network 1004 using any communications protocol as understood in the art, and storage unit 1018 configured to store data repositories 1020a-1020n (collectively 1020). The data repositories 1020 may be configured to store data associated with each publisher, such as attributes of inventory, so that the processing unit 1010 may process that data to generate ‘rare crowd’ inventory, as described herein. The data stored in the data repositories 1020 may further include price and volume data associated with the various publishers so that the processing unit 1010 may assist in apportioning and programmatically purchasing the ‘rare crowd’ inventory for media buyers (e.g., ad agencies, advertisers, or ad exchanges, etc.).

In operation, the computing system 1002 may communicate via the network 1004 with one or more publisher server 1006 and/or exchange server 1008 to collect information, such as ad space inventory, target attributes, historical traffic data, historical placement data, and any other data that may be utilized in performing the functionality in accordance with the principles of the present invention. The information may be collected periodically or aperiodically in either a push or pull configuration. In one embodiment, the information may be collected in real time In another embodiment, the information may be collected every hour, two hours, four hours, daily, weekly, or any other time period. Alternatively, the information may be collected during and/or after each advertising campaign to provide the ‘rare crowd’ system with the ability to analyze delivery performance to ensure proper targeting, and make adjustments going forward to better target specific inventory desired by an advertiser as established by an ad campaign. By monitoring delivery performance as well as attributes of inline traffic during time periods (e.g., 7 am-8 am), events (e.g., online television show), or sites (e.g., travel section of online newspaper), the system may better determine available combination of attributes to reach a more targeted inventory for future deliveries during those periods. An interface may enable a user to submit attributes, including a combination or set of attributes, for creating an inventory to which an advertisement is to be delivered. In one embodiment, the interface may be a user interface into which the user may select or otherwise submit attributes. Alternatively, the interface may be a software interface that is configured to receive attributes from another software system, such as a publisher software system or exchange software system.

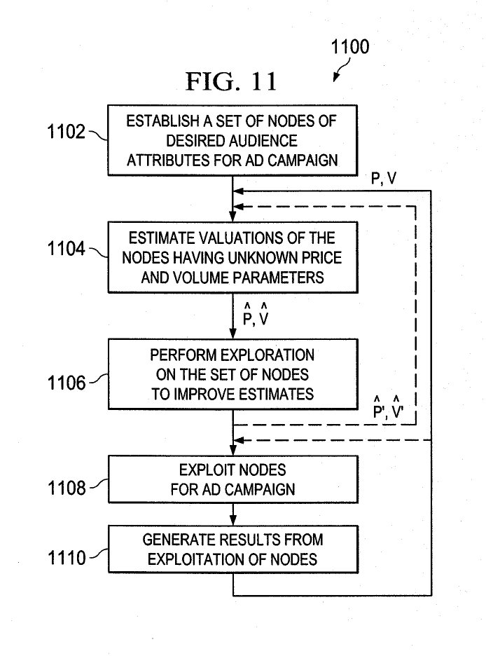

As understood in the art, advertising is driven by a number of factors, including inventory volume and valuation of the inventory. The inclusion of a ‘rare crowd’ inventory fits into traditional advertising metrics, but as a result of not having historical knowledge of a ‘rare crowd’ inventory because current advertising participants (e.g., publishers, agencies, and other media planners) have historically be unable to attain such information. Hence; in order to properly plan an ad campaign inclusive of the ‘rare crowd’ inventory (e.g., allocate and purchase the ‘rare crowd’ inventory), the principles of the present invention provide for generating the ‘rare crowd’ inventory and determine valuation and volume of the ‘rare crowd’ inventory. Such a process may be performed dynamically and/or iteratively, as provided in FIG. 11.

Valuation of Inventory

Valuation of inventory is complex with large numbers of attributes (e.g., 4, 6, 8, 10, or more). In one embodiment, the use of extrapolation of values of nodes with a single attribute combined with combination bonuses and the valuations of “child” nodes may be used to determine valuation of ‘rare crowd’ inventory. For clarity, valuation is the value that an advertiser or its agency places on inventory, and price is an estimate or actual amount of money that the inventory costs to purchase. In determining valuation, at the start or during an ad campaign, advertisers or their agencies may submit a value that is placed on inventory attributes. The submission may be on attribute components (e.g., A, B, C) or combination of the attribute components (e.g., ABC). These lower tier valuations allow for a graph of combinations of inventory attributes of which an advertiser is seeking for advertising, to be generated by using certain techniques, such as mathematical computation (e.g., extrapolation and/or interpolation) to estimate valuations of as many combinations of inventory attributes within the graph as possible. That is, the more higher tiered combinations with a certain attribute (e.g., AB), the more helpful it is to have a valuation from an advertiser, its agency, publisher, ad network (e.g., sales team), or other party, to place a value on node AB (i.e., combination of inventory attributes A and B), as opposed to simply nodes A and B individually (although having a valuation of inventory attributes A and B individually is helpful for valuing node AB). The valuations may be made by a human submitting a value for inventory (e.g., tier 3 nodes) or by a machine placing a valuation on nodes. The more nodes that are valued, the better the model as a higher;number of nodes with valuations helps the advertiser and/or publisher determine the value of the inventory versus actual price being paid along with volume for that inventory.

By way of example, given attributes A, B, C & D, each with value V. The value of node ABCD is a function of the value of nodes ABC, ABD, ACD, and BCD, where the value of node ABC is a function of the values of nodes AB, AC, BC, and so on. This node valuation process allows specific combinations to have values determined explicitly or inherited by a function of children node valuations. In determining node valuation explicitly or through inheritance, extrapolation and/or estimation may be made for each node with increased number of attributes from child nodes. In some cases, valuation of the attribute components, such as A, B, C, may be known, while in other cases, valuation of attribute components may be ascertained during an ad campaign. Equation 1 below provides for a valuation calculation, where the function f may be a maximum function or otherwise. If using a maximum function, the value of node ABCD (i.e., V_{ABCD}) may be determined as the maximum of any of the values of the child nodes of node ABCD. Other functions may be utilized to approximate or extrapolate values of parent nodes.

V_{ABCD}=f(V_{ABC}, V_{ABD}, V_{ACD}, V_{BCD}) (eqn. 1)

Inventory Procurement Algorithm

Inventory procurement may be performed using a two phase algorithm, including exploration and exploitation. These phases are used in every iteration of the calculation.

Exploitation

Exploitation takes advantage of facts that are known or can be extrapolated about inventory. These facts may include price, valuation, available volume per inventory source, etc. The goal of exploitation is to maximize multiple goals and minimizing impact of constraints. The goal of an ad campaign is to maximize the utility of the audience for the advertiser, which is the sum over all impressions of the difference between what the advertiser values an impression to be and how much they paid for that impression, as provide in equation (2).

Σ_{i∈win}v(i)−p(i) eqn. (2)

where v is the valuation of specific combination of inventory attributes (node), and p is actual price paid (or anticipated to pay) for the inventory.

Constraints on exploitation may be as simple as daily spend goals or as complex as having several simultaneous constraints. Specific examples of these constraints include:

(1) Daily Budget Goals:

$${\sum }_{s} {B}_{s} \leq B ,$$

where Bₛ is the budget for segment s and B is daily budget.

(2) Total Daily Impression minimum (or equivalently the maximum average cost per impression):

$${\sum }_{s} {B}_{s} / {p}_{s} \geq N .$$

(3) Node impression limits, based on available inventory: ∀s:Bₛ/pₛ≦Iₛ, where Iₛ is the volume for segment s, Bₛ is budget for segment s, pₛ is price paid (or anticipated to be paid) for segment s, and N is minimum number of impressions.

(4) Reach constraints, where specific inventory attributes (targeting, audience, placement, geo, inventory source) may be limited in total lifetime spend. As an example, an ad campaign may have targeting to serve in the U.S., but not to serve more than 10% of the budget any specific state.

(5) Smoothness constraints operate to limit spend rate on specific dimensions or attributes relatively so as to be even over a timeframe.

(6) Node export limits are enforced by one or more inventory source(s) and operate to limit the number of “orders” an advertiser can have at any one time with the inventory source(s).

(7) Node export count constraints constraint that can be enforced to limit the number of a times a node is used to create an object in an inventory source.

(8) Minimum budget constraint is the smallest amount of budget that is allocated to any node and may be defined as ∀s:Bₛ≧Bₘᵢₙ.

This algorithm can be solved with many different approaches. One approach to solving this algorithm is a modification of a multi-dimensional knapsack problem. Linear programming solvers are applicable here, but may have performance problems. Currently, the requirement is that this problem be solved on the order of minutes and not hours so any algorithm selected for solving the algorithm given the number of constraints has to perform within minutes or even seconds.

Assumptions

There are two key assumptions made in the exploitation algorithm. These assumptions are that both a price range and volume range is known for each node. These assumptions are always true-based for use of a model extrapolation approach described below.

Node Model Extrapolation

In managing a large graph of nodes, price and volume is to be determined for each node. Such nodal price and volume determination may be performed using extrapolation and leveraging the fact that there is a submodular and monotonic relationship between price and volume for each node.

As assumption is made that the volume of a more specific (more target attributes) node is the same or less than a less specific node. That is, the more attributes to be targeted, the fewer inventory members with those attributes. For example, there are fewer female, auto purchase intenders with children than female, auto purchase intenders.

Additionally, an assumption is made that the price (as determined by the market or inventory source) is the same or higher for more specific nodes. That is, the more attributes of an inventory, the more an advertiser is willing to pay for that more specific inventory because the detailed level of attributes is considered to result in a higher chance that the audience can relate to the advertiser's message and become a consumer of the advertiser's product offering. For example, female, auto purchase intenders with children is more expensive than female, auto purchase intenders for advertisers because the audience is more specific.

Using submodularity and monotonicity, an iteration over the graph may be performed and ranges for price and volume may be computed. These prices and volumes are then used in the exploitation algorithm.

Exploration

Exploration involves choosing which unknown nodes to export into orders or tiers. Exploration is generally performed to maximize the information gained from information gathered so that the node model extrapolation is better refined and ranges of price and volume for each node may be further narrowed. By narrowing the price and volume for each node, ad spend and advertising efficiency is improved.

In one embodiment, the algorithm used for exploration is a simple max cover approach, where nodes are selected to maximize the breadth of coverage of attributes and combination (tuples) of attributes. Alternative exploration algorithms may be utilized to determine price and volume of nodes in a set of nodes established by inventory attributes for an ad campaign in accordance with the principles of the present invention.

Exploration vs Extrapolation

A third aspect to the inventory procurement algorithm is to balance between the two phases (i.e., exploration and exploitation) of the algorithm. In one embodiment, an initial iteration may be 100% exploration (assuming no or limited knowledge exists, for the nodes defined by inventory attributes). Often some insight into volume and price of nodes exist from historical ad campaigns, but due to the dynamic nature of the market, historical information is not absolute and, thus, cannot be treated as such. As a result, it is generally just as easy to initialize the price and volume of each node at an educated guess value, possibly from historical information, or simply zero.

After an initial iteration of the exploration of the nodes, which, as previously described, includes extrapolation, a balance of exploiting known nodes and exploring new nodes may be performed. Until some level of confidence (e.g., optionally specified by a predetermined confidence value) on a specific number of nodes on the graph, exploration is performed. In one embodiment, the level of confidence may be a Boolean value. Alternatively, a number ranging from 0 to 1 may be used. The confidence value is indicative of how much certainty that a valuation, price, and/or volume of a node exists as a result of the process described herein (see FIG. 11, for example). As an example, if a parent node with four attributes is estimated as a result of having all of its child nodes, then the estimate has higher a confidence than if one or more of the child nodes does not have estimates or actual values of attributes (e.g., price or volume). By continuing to perform exploration, knowledge of the price and volume of the nodes continues to improve until the desired confidence level is achieved. This confidence is called insight. Once insight hits a configurable or predetermined level that is adequate for the given graph, then exploration may be reduced or ceased and the algorithm may start, increase, or only perform exploitation of the nodes. The level of insight used can be a function of spend pacing, time remaining to explore, or an arbitrary value. In one embodiment, the confidence level is determined based on a difference between an estimated valuation and explored valuation (e.g., less than 10% difference exists between (i) estimated price and explored price or (ii) explored prices of successive explorations of a node).

With regard to FIG. 11, a flow diagram of an illustrative inventory procurement process 1100 that may be executed by a computing system, such as computing system 1002, in accordance with the principles of the present invention is shown. The inventory process 1100 may be used to generate a ‘rare crowd’ inventory as well as non-'rare crowd' inventory. The process 1100 may start at step 1102, where a set of nodes of desired inventory attributes for an ad campaign is established. In establishing the set of nodes, (i) component attributes (e.g., male, 18-25 years old, recent home purchaser, married within last 12 months) may be received from an advertiser or its agency, and (ii) unique combinations of the component attributes of the desired inventory may be generated. In the case of having 10 component attributes, for example, unique combinations of 2-10 of the component attributes may be formed. The established set of nodes may be stored on a storage unit. In one embodiment, the established set of nodes may be stored in a data repository, such as a database, that is inclusive of parameters (e.g., price and volume parameters) associated with each of the set of nodes. In one embodiment, nodes of all combinations of the component attributes may initially be established. Alternatively, fewer than all combinations of the component attributes may initially be established. As exploration and exploitation processes are performed, nodes having (i) low or no volume and/or (ii) low or no price may be eliminated or cease to be further processed. Low volume and low price may be determined based on having limited commercial value for an advertiser, as may be established as constraints in the advertising campaign by the advertiser, its agency, or operator of the ‘rare crowd’ inventory generation system.

At step 1104, valuations of the nodes having unknown price and volume parameters may be estimated. In terms of being unknown, the price and volume parameters may be considered as being unknown if an actual purchase of a node (i.e., node formed of a component attributes or a combination of multiple component attributes) has not yet been made or a certain amount of time has elapsed since previously purchasing (i.e., exploiting, as described below) a node. In one embodiment, estimations may be performed using extrapolation and/or interpolation. It should be understood that alternative estimation functionality may be performed to estimate in accordance with the principles of the present invention. First estimations may include generating initial valuations of the component attributes of the desired inventory. In generating the initial valuations, historical valuations of the component attributes may be utilized to estimate the initial valuations. Alternatively, the initial valuations may be initialized independent of estimates (e.g., valuations set to 0 or other value) may be used In addition to estimating nodes of component attributes (e.g., nodes with single component attributes A, B, C), initial valuations of the unique combinations of the component attributes may be generated based on the initial estimates of the component attributes, and each level of combinations of attributes (i.e., combination of 2, 3, 4, . . . n attributes) may have initial values set based on lower numbers of combinations or child nodes (i.e., nodes with 8 combinations are based on nodes with 7 or fewer combinations). In one embodiment, in estimating the valuations of the unique combinations, a mathematical function, such as a maximum function of each of the component attributes used to form the from step 1104, estimated price \hat{P} and volume \hat{V} parameters may be generated and stored in the data repository with respective nodes. Such estimation may include estimating parent nodes from child nodes, where the child nodes are nodes of component attributes or combinations of component attributes. It should be understood that as child node valuation estimates improve or are actually determined through the exploitation process, estimates of parent nodes may also improve though use of the mathematical function.

At step 1106, exploration on the set of nodes to improve estimated price and volume of the nodes may be performed. The exploration may include attempting to purchase each of the nodes from available sources that have inventory that matches the component attributes of the nodes. As a result of attempting to purchase the nodes, improved estimates of both price \hat{P}′ and volume \hat{V}′ parameters may be determined. These improved estimates of both price \hat{P}′ and volume \hat{V}′ parameters may be fed back to step 1104, where estimate valuations may continue to be performed throughout an advertising campaign.

At step 1108, the nodes may be exploited for the ad campaign. In one embodiment, the nodes to be exploited may be limited to those that have been estimated through the exploration process of step 1106. If, for example, the exploration process at step 1106 performs estimates on only nodes with single component attributes (e.g., nodes A, B, C) on a first exploration pass so that estimates may be better made on combinations with two component (e.g., nodes AB, AC, BC) on a second exploration pass, then the exploitation of the nodes, on the first pass may be limited to the nodes with single component attributes. Such an iterative process (i.e., exploit nodes with single component attribute on first pass, exploit nodes with single and two component attributes on second pass, exploit nodes with single, two, and three component attributes on third pass, and so on) may be performed throughout an entire advertising campaign.

In one embodiment, steps 1106 and 1108 may be combined or performed simultaneously as some advertising platforms, such as real-time bidding (RTB) platforms, require purchase, while other platforms, such as non-real-time bidding platforms, allow for determining whether inventory exists without having to purchase. In the event of combining, as actual purchases of inventory are made, actual prices within nodes may be determined and estimates may no longer be needed (unless a certain amount of time, such as a day, a week, a month, etc. passes without that inventory being purchased so that an estimate is once again needed for that node).

In an one embodiment, rather than continuing to repeat the estimation 1104 and exploration 1106 steps throughout the entire advertising campaign, the process 1100 may determine a confidence value that is indicative of having knowledge the valuation of the nodes so that in response to the confidence value crossing a confidence value threshold, estimates are no longer needed and exploitation of the nodes in the marketplace may be exclusively performed (i.e., exploration of the nodes with confidence values over a confidence value threshold may cease to be performed). In another embodiment, a confidence value of a node may be adjusted downward based on a time duration since last purchasing a node in the marketplace (i.e., from a publisher or other ad placement service, such as an SSP), which may cause further exploration of a node that confidence level drop below the confidence level threshold.

At step 1110, results from exploitation of the nodes may be generated. The results may include a report that shows price and volume parameters of nodes that were actually booked or purchased from the marketplace. The report may show a difference between estimated price \hat{P}′ and volume \hat{V}′ parameters and actual price P and volume V parameters of each node. The actual price P and volume V parameters may be fed back to step 1104, where valuations of nodes having unknown price and volume parameters may continue to be estimated. If, for example, the report shows that there is a positive difference between value and price of inventory (i.e., one or more nodes), then if there is acceptable volume, it is beneficial for the advertiser to purchase that inventory. On the publisher or supply side, the closer the difference between value and price, that means that the seller is getting maximum value for that inventory. As a result of having value for each or many nodes within a set of nodes, the more transparency there is in the inventory for users of the principles of the present invention.

The process 1100 may be performed using constraints on exploitation of nodes as previously described. These constraints may be applied through use of knapsack problem mathematics used in combinatorial optimization, as understood in the art, or other combinational constraint solving mathematics, including, but not limited to, multiple-choice knapsack problem mathematics, linear programming with a “greedy” algorithm, linear equations, Lagrange multiplier, “limited resources” algorithm, etc.

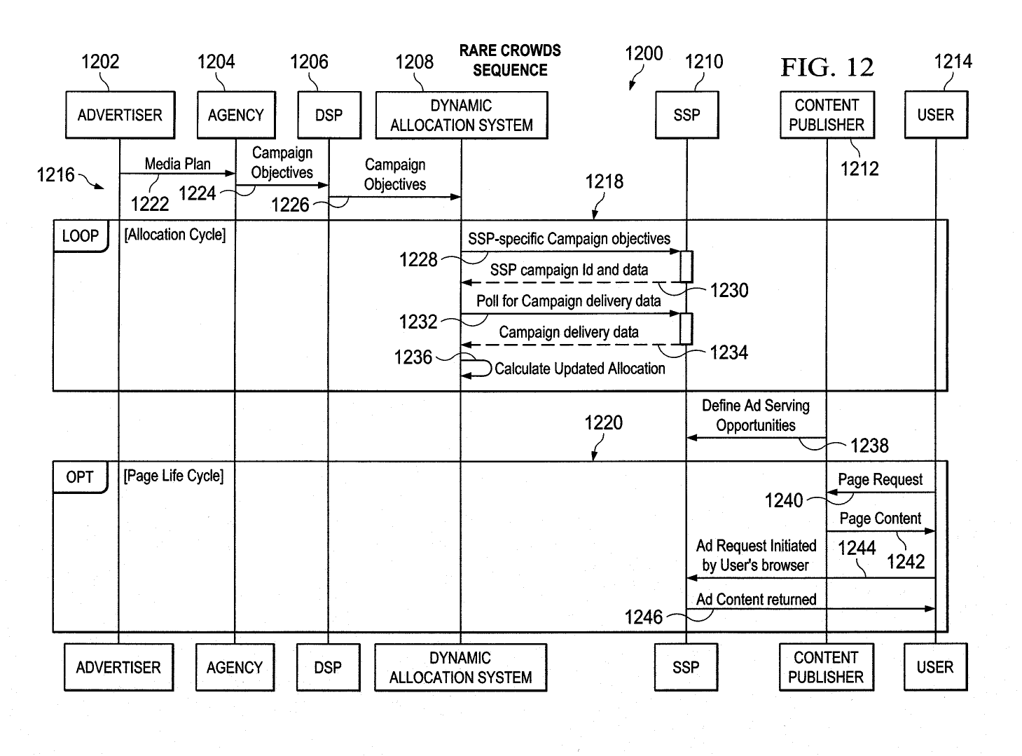

With regard to FIG. 12, a sequence diagram of a process 1200 for performing an advertising campaign that includes a ‘rare crowd’ inventory is shown. The process 1200 is inclusive of a number of participants, including an advertiser 1202, agency 1204 of the advertiser 1202, demand side platform 1206, dynamic allocation system 1208 performed by a computing system, supply side platform 1210, content publisher 1212, and user 1214 who views content (e.g., webpage) of the content publisher 1212.

The process 1200 includes three portions, including an advertisement campaign set-up portion 1216, allocation cycle 1218, and page life cycle 1220. The advertisement campaign set-up portion 1216 may include the advertiser 1202 submitting a media plan to the agency 1204 at step 1222. At step 1224, the agency 1204 may communicate campaign objectives to the demand side platform 1206, which, in turn, may communicate the campaign objectives to the dynamic allocation system 1208.

Within the allocation cycle 1218, the dynamic allocation system 1208 may communicate SSP-specific campaign objectives to the supply side platform 1210 at step 1228. At step 1230, the SSP 1210 communicates the SSP campaign ID and data to the dynamic allocation system 1208. In response, the dynamic allocation system 1208 polls the SSP for campaign delivery data at step 1234. The campaign delivery data may provide for inventory attributes that are available via the SSP 1210. At step 1236, the dynamic allocation system 1208 calculates updated allocations. That is, the dynamic allocation system 1208 operates to assess the availability of different nodes having unique combinations of inventory attributes to estimate valuations of those nodes, as previously described herein. At step 1238, the content publisher 1212 may communicate defined ad serving opportunities to the SSP 1210. It should be understood that the SSP 1210 collects inventory attributes so that the dynamic allocation system 1208 is able to estimate the different nodes requested via the campaign objectives 1226 from the agency 1204.

Within the page life cycle 1220, the user 1214 may make a webpage request at step 1240 from the content publisher 1212 at step 1240. At step 1242, the webpage content may be communicated to the user 1214. As understood in the art, the webpage may include one or more ad spaces inclusive of an ad tag that causes a browser of the user to request an ad at step 1244 from the SSP 1210. Responsive to the ad request, the SSP may communicate ad content to the browser of the user 1214 for display at step 1246.

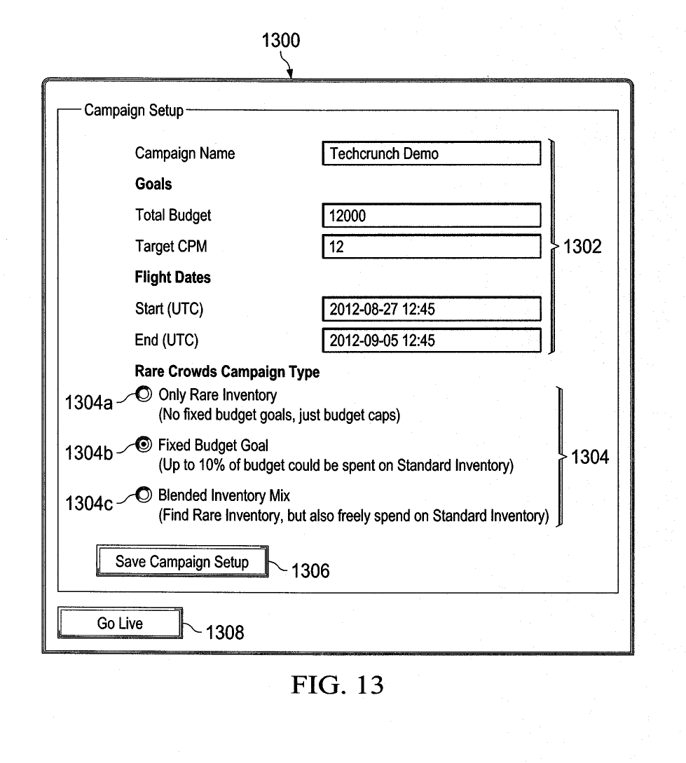

With regard to FIG. 13, a screen shot of an illustrative user interface 1300 that enables an advertiser or its agency to create an ad campaign inclusive of ‘rare crowd’ inventory is shown. A number of input fields 1302 may allow the advertiser to enter an ad campaign name and submit ad campaign goals, including total budget, target CPM, and start and end dates. Additionally, the advertiser may select one of a number of different campaign types 1304, including only ‘rare crowd’ inventory 1304a, fixed budget goal 1304b, and blended inventory mix 1304c. Once selected, the advertiser may save the campaign setup by selecting soft-button 1306. Once ready to initiate the ad campaign, the advertiser can select the “go Live” soft-button 1308.

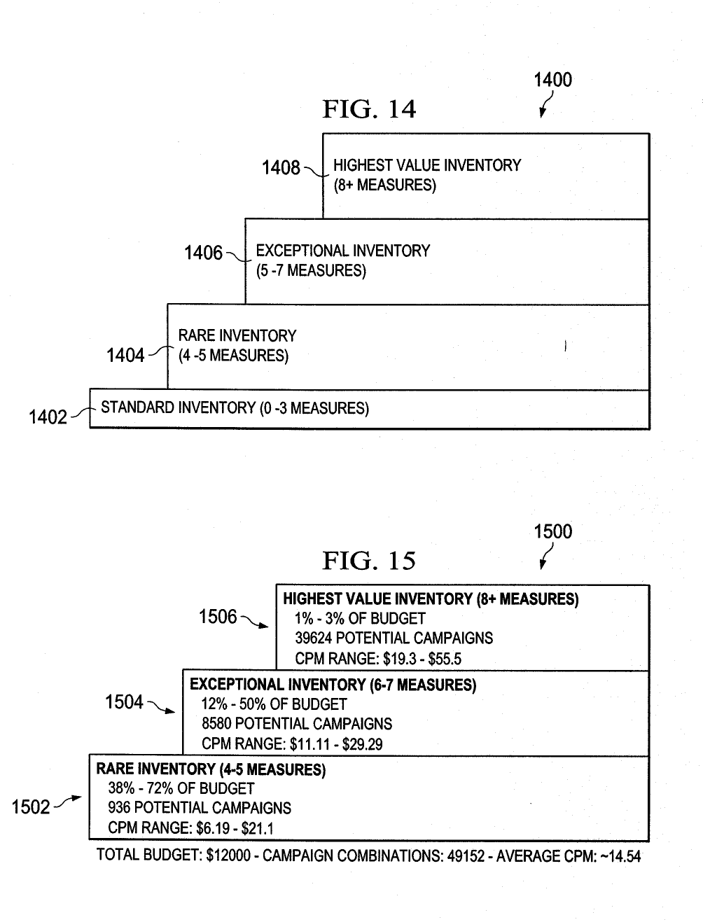

With regard to FIG. 14, a stack of illustrative inventory definitions 1400 is shown. The inventories range from standard inventory (0-3 attributes or measures) 1402, rare inventory (4-5 attributes), exceptional inventory 1406 (5-7 attributes), and highest value inventory (8+attributes) 1408. As previously described, a ‘rare crowd’ inventory is inclusive of the inventories 1404-1408.

With regard to FIG. 15, a stack of illustrative ‘rare crowd’ inventory with ad campaigns examples 1500 is shown. Each of the examples of the respective inventories 1502, 1504, and 1506 include budget ranges, potential campaigns identified in each of the different inventories., and CPM ranges for each of the inventory. As shown a total budget of $12,000 is available and 49,152 campaign combinations are available from the different inventories. Utilizing the principles of the present invention as provided with regard to FIG. 11, audience inventory that had previously only been able to be available as standard inventory 1402 (FIG. 14) may now be made available to advertisers as ‘rare crowd’ inventory, which increases the value of the inventory for both the publisher and advertiser.

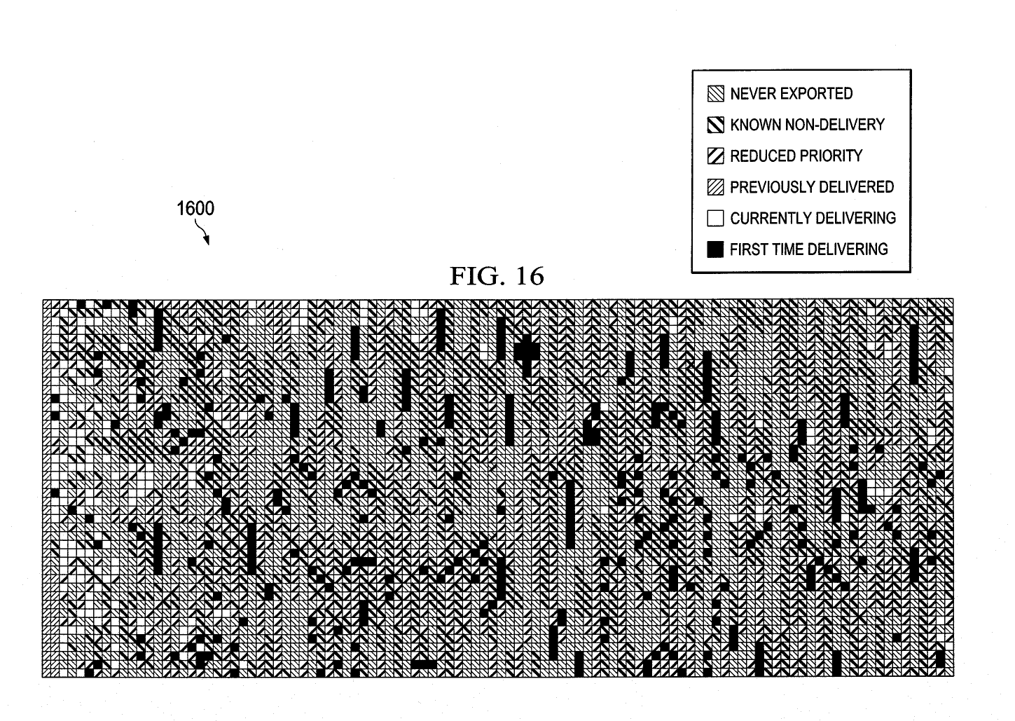

With regard to FIG. 16, a screen shot of an illustrative map or graph 1600 showing allocations of different levels of ‘rare crowd’ inventory is shown. Each of the squares in the map 1600 is representative of a node inclusive of an inventory attribute components and combinations of inventory attributes. This map 1600 may be used to assess the different tiers of inventory attributes, and allows for a user to quickly observe all of the nodes simultaneously. Moreover, by using colors to illustrate information, such as price and/or volume of those nodes, a user may be able to easily see how the process is performing. Still yet, the colors may indicate whether a node is an estimate or actual value as the process of FIG. 11 is operating. It should be understood that a variety of different maps, reports, lists, or otherwise may be utilized to show how ‘rare crowd’ inventory is being established, estimated, valued, booked, and so on.

The previous description is of a preferred embodiment for implementing the invention, and the scope of the invention should not necessarily be limited by this description. The scope of the present invention is instead defined by the following claims.

What is claimed is:

1. A method of procuring an advertising inventory over a communications network, said method comprising:
establishing, by a computing system, a set of nodes defined by desired component attributes of inventory for an advertiser for an ad campaign;
storing, by the computing system, the established set of nodes on a storage unit;
estimating, by the computing system, valuation of nodes having unknown price and volume parameters;
exploring, by the computing system, the set of nodes to determine estimated price and volume parameters for the nodes;
exploiting, by the computing system, the set of nodes for the ad campaign, the exploitation inclusive of at least one extrapolated node having an estimated valuation; and
generating, by the computing system, results of the exploited set of nodes for the ad campaign.

2. The method according to claim 1, wherein the estimating includes extrapolating and/or interpolating valuations of the nodes having unknown price and volume parameters.

3. The method according to claim 1, wherein establishing the set of nodes includes:
receiving component attributes of the desired inventory from the advertiser, the component attributes being at least four in number; and
generating unique combinations of the component attributes of the desired inventory, the unique combinations including unique combinations of all of the component attributes up to and including all of the component attributes.

4. The method according to claim 3, further comprising generating initial valuations of the component attributes of the desired inventory.

5. The method according to claim 4, further comprising generating second initial valuations of the unique combinations based on the initial valuations of the component attributes.

6. The method according to claim 5, where generating second initial valuations of the unique combinations includes applying a maximum function to the initial valuations of the component attributes that are used to form the respective unique combinations.

7. The method according to claim 5, wherein the initial valuations and second initial valuations are estimated price and volume parameters of each node.

8. The method according to claim 1, wherein exploring the set of nodes further includes estimating valuations of parent nodes based on explored child nodes of respective parent nodes.

9. The method according to claim 1, wherein exploiting the nodes includes booking ad placements for the ad campaign for the set of nodes.

10. The method according to claim 9, wherein exploiting the nodes includes constraining the nodes based on at least one budget of the ad campaign.

11. The method according to claim 1, further comprising transitioning from exploring the set of nodes to exploiting the set of nodes in response to exploring the set of nodes.

12. The method according to claim 11, wherein transitioning is performed in response to determining that a confidence value of the explored set of nodes crosses a threshold value.

13. The method according to claim 1, wherein generating the results of the exploited set of nodes includes generating a report inclusive of actual price and volume parameters for the set of nodes.

14. The method according to claim 1, further comprising feeding back explored price and volume parameters to respective nodes to improve estimates.

15. The method according to claim 14, further comprising feeding back actual price and volume parameters of the set of nodes to each of the respective set of nodes.

16. The method according to claim 15, wherein feeding back the actual price and volume parameters throughout an entire duration of an advertising campaign to estimate valuations of the nodes having unknown price and volume parameters.

17. A system for procuring an advertising inventory over a communications network, said system comprising:
a storage unit configured to store at least one data repository; and
a processing unit in communication with said storage unit, and configured to:
establish a set of nodes defined by desired component attributes of inventory for an advertiser for an ad campaign;
store the established set of nodes in the at least one data repository;
estimate valuation of nodes having unknown price and volume parameters;
explore the set of nodes to determine estimated price and volume parameters for the nodes;
exploit the set of nodes for the ad campaign, the exploitation inclusive of at least one extrapolated node having an estimated valuation; and
generate results of the exploited set of nodes for the ad campaign.

18. The system according to claim 17, wherein said processing unit, in estimating, is further configured to extrapolate and/or interpolate valuations of the nodes having unknown price and volume parameters.

19. The system according to claim 17, wherein said processing unit, in establishing the set of nodes, is further configured to:
receive, via an input/output unit, component attributes of the desired inventory from the advertiser, the component attributes being at least four in number; and
generate unique combinations of the component attributes of the desired inventory, the unique combinations including unique combinations of all of the component attributes up to and including all of the component attributes.

20. The system according to claim 1, wherein said processing unit, in exploring the set of nodes, is further configured to estimate valuations of parent nodes based on explored child nodes of respective parent nodes.

21. The system according to claim 1, wherein said processing unit, in exploiting the nodes, is further configured to include booking ad placements for the ad campaign for the set of nodes.

22. The system according to claim 21, wherein said processing unit, in exploiting the nodes, is further configured to constrain the nodes based on at least one budget of the ad campaign.

23. The system according to claim 1, wherein said processing unit is further configured to transition from exploring the set of nodes to exploiting the set of nodes in response to exploring the set of nodes.

24. The system according to claim 23, wherein said processing unit, in transitioning, is further configured to transition in response to determining that a confidence value of the explored set of nodes crosses a threshold value.

25. The system according to claim 17, wherein said processing unit is further configured to feed back explored price and volume parameters to respective nodes to improve estimates.

26. The system according to claim 25, where said processing unit is further configured to feed back actual price and volume parameters of the set of nodes to each of the respective set of nodes.

27. The system according to claim 26, wherein feeding back the actual price and volume parameters throughout an entire duration of an advertising campaign to estimate valuations of the nodes having unknown price and volume parameters.

28. The system according to claim 17, wherein the established set of nodes includes at least four component attributes.
